(19) United States
(12) Patent Application Publication
(10) Pub. No.: US 2013/0300912 A1
(43) Pub. Date: Nov. 14, 2013

(54) Dictionary Learning for Incoherent Sampling

(71) Applicants: Ivana Tosic, Berkeley, CA (US); Sapna A. Shroff, Menlo Park, CA (US); Kathrin Berkner, Los Altos, CA (US)

(72) Inventors: Ivana Tosic, Berkeley, CA (US); Sapna A. Shroff, Menlo Park, CA (US); Kathrin Berkner, Los Altos, CA (US)

(73) Assignee: RICOH INNOVATIONS, INC., Menlo Park, CA (US)

(21) Appl. No.: 13/471,290

(22) Filed: May 14, 2012

(51) Int. Cl. G06F 15/18; G02B 13/16

(52) U.S. Cl. 348/335; 706/12; 348/E05.03

(57) ABSTRACT

Machine learning techniques are used to train a “dictionary” of input signal elements, such that input signals can be linearly decomposed into a few, sparse elements. This prior knowledge on the sparsity of the input signal leads to excellent reconstruction results via maximum-aposteriori estimation. The machine learning imposes certain properties on the learned dictionary (specifically, low coherence with the system response), which properties are important for reliable reconstruction.

### BACKGROUND OF THE INVENTION

1. Field of the Invention

This invention relates generally to the reconstruction of inputs to a linear system from the observed outputs, including for example the reconstruction of an object from images captured by a plenoptic system.

2. Description of the Related Art

Compressive sampling (sensing) is a theory that has emerged recently from the signal processing efforts to reduce the sampling rate of signal acquisition. However, almost all, if not all, prior work is based on the use of special random measurement matrices in conjunction with well-known bases, such as wavelets. These approaches solve a different problem than the reconstruction problem that we address, in which the measurement matrix (i.e., the system response matrix) is known and a customized basis is tailored to both the measurement matrix and the expected class of input signals.

Separately, dictionary learning for sparse signal models has also been a popular topic recently. However, almost all work in dictionary learning assumes that the input signal is directly observed. That is, it assumes that the system response matrix is the identity matrix. These approaches also are not applicable to the reconstruction problem that we address, since in our cases the system response matrix is far from the identity matrix.

Thus, there is a need for reconstruction approaches that can overcome the shortcomings of the prior art.

### SUMMARY OF THE INVENTION

The present invention overcomes the limitations of the prior art by using machine learning techniques to train a “dictionary” of input signal elements, such that input signals can be linearly decomposed into a few, sparse elements. This prior knowledge on the sparsity of the input signal leads to excellent reconstruction results via maximum-aposteriori estimation. The learning method imposes certain properties on the learned dictionary (specifically, low coherence with the system response), which properties are important for reliable reconstruction.

A system can be characterized by y=Ax+η, where x represents input to the system, A represents a rank-deficient system response matrix, η represents system noise and y represents output of the system. The input x is further represented by x=Φc, where Φ is a “dictionary” for the system and the coefficients c are sparse.

One aspect of the invention concerns selection of the dictionary Φ, for a given system response matrix A and class of input signals x. The dictionary Φ is determined by a machine learning method. An initial dictionary estimate Φ is selected and then improved by using B samples selected from a training set and organized in a matrix X=[x₁ x₂ . . . x_{B}], referred to as a “sample” X in the following. The improvement is based on an objective function that rewards a low error between the sample X and the sample representation ΦC where C=[c₁ c₂ . . . c_{B}] is the coefficient representation of X, and that also rewards a low coherence between A and Φ. Low coherence between A and Φ is important for reliable reconstruction.

One specific approach is based on the following. A sample X is selected. In an “inference” step, C is estimated based on a sparse prior and assuming the current dictionary estimate Φ. In other words, given Φ, find C. In a complimentary “adaptive learning” step, Φ is estimated, based on assuming the current estimate of C. That is, given C, find Φ. This is repeated for the next sample X and so on. In one formulation, both of these steps are convex optimization problems, so they can be solved in a computationally efficient manner.

Another aspect of the invention concerns reconstructing x once the dictionary Φ has been selected. The problem is to reconstruct the input x₁ that corresponds to an observed output y₁. In one approach, the input x₁ is a maximum-aposteriori estimate based on y₁, A and the determined dictionary estimate Φ.

There are many potential applications for the approaches described above. One class of applications is for plenoptic systems. Plenoptic systems are more advantageous than conventional imaging systems because they can provide additional capabilities and functionalities such as instantaneous multi-spectral imaging, de-focusing and 3D imaging. This is achieved via optical modifications (insertion of a micro-lens array and optional filter module) in conjunction with advanced digital image (or 3D scene) reconstruction and processing algorithms. However, plenoptic systems historically have provided these additional functionalities at the expense of significantly reduced spatial image resolution. It is possible to model the plenoptic system as a linear system, but the system response matrix (referred to as the pupil image function or PIF) is rank deficient. Thus, the dictionary-based reconstruction methods described above can be used advantageously with plenoptic systems to reconstruct higher resolution images even though the system response is rank deficient.

In addition to plenoptic cameras, many other systems deal with the same problem of reconstruction from a limited number of measurements, especially medical imaging systems such as ultrasound tomography or MRI.

Other aspects of the invention include methods, devices, systems and applications related to all of the above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram of a dictionary-enhanced system according to the invention.

FIG. 2 is a flow diagram illustrating one method for determining a dictionary.

FIG. 3 is a simplified diagram of a plenoptic system.

FIG. 4 are sample images taken from a training set used for dictionary learning.

FIGS. 5a-d are images illustrating dictionary-based reconstruction for a doll object.

FIGS. 6a-d are images illustrating dictionary-based reconstruction for a Lena object.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

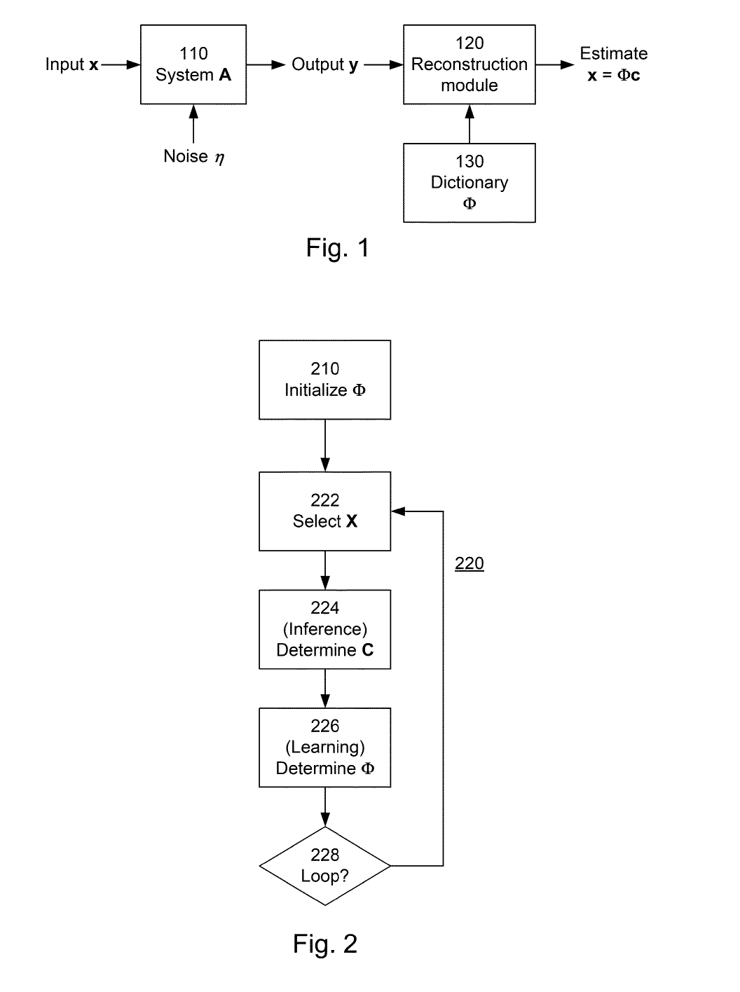

FIG. 1 is a block diagram of a dictionary-enhanced version of a system 110 according to the invention. The system 110 can be characterized by a linear model

y=Ax+η, (1)

where x represents the input to the system, A represents a system response matrix, η represents system noise and y represents the output of the system.

The reconstruction problem is to find x, given y and A. In other words, estimate the original input signal, given measurements of the system outputs and given a linear characterization of the system. Since Eqn. 1 is linear, the reconstruction problem is a linear inverse problem. The existence and uniqueness of the solution depends on the properties of the system response matrix A. If the matrix A is invertible and well-conditioned, the reconstruction can be solved by inverting A and applying x=A⁻¹y.

In many cases, however, the matrix A is a rectangular matrix and rank deficient, and the linear system is under-determined. This is the case when the number of rows of A, denoted as M, is smaller than the number of columns N, or when the rank of A is smaller than N even if M>N. In these cases, we can search for the most probable solution for x that approximately satisfies the given linear system. Formally, we are looking for an estimate \hat{x} such that \hat{x}=max P(x|y); it is the maximally probable \hat{x}, given y. That is, we would like to find the maximum-aposteriori (MAP) estimate for x.

MAP estimation can also allow us to incorporate some prior information about the signal or image. That is, the probability of measurements y can be augmented by some additional prior information on the signal x. One prior that has good performance for signal reconstruction is sparsity. The sparsity prior assumes that the input signal x is sparse in a certain dictionary. A dictionary [symbol] in [symbol] ^{N} is a set of {φₖ}ₖ₌₁^{L}⊂ [symbol] ^{N} of unit norm vectors, i.e., ∥φₖ∥₂=1 ∀k. Elements of the dictionary are called atoms. The dictionary is complete when span{φₖ}= [symbol] ^{N}, i.e., when any vector in [symbol] ^{N} can be represented as a linear combinations of atoms. When span{φₖ}= [symbol] ^{N} and atoms are linearly dependent, the dictionary is overcomplete. A matrix whose columns are atoms is called the dictionary matrix Φ. For simplicity, we will refer to the matrix Φ as the dictionary. Given, these definitions, the sparsity prior assumes that the input signal x can be expressed as

x=Φc, (2)

where the vector of coefficients c has a small number of non-zero entries. That is, c is sparse. If the signal dimension of x is N×1 (or an image of size \sqrt{N}×\sqrt{N} in a vectorized form), and the dictionary Φ size is N×L, the vector of coefficients c has size L×1 with K non-zero elements, where K<<N. L can be equal to N (complete basis set), but it is usually assumed that L>N (overcomplete basis set).

In FIG. 1, reconstruction is performed by the reconstruction module 120 and dictionary 130. Given an observed output y, the reconstruction module 120 calculates the corresponding coefficients c, as described in further detail below. It then calculates the estimated input x according to Eqn. 2.

When certain conditions on A and Φ are met, it has been shown that sparse c (and hence x) can be reconstructed using convex optimization from a small number of measurements. This number can be well below the Nyquist limit and it depends on the sparsity of c. Generally, the number of linearly independent measurements (i.e., the rank of A) depends on the sparsity of c. If number of measurements is small, then c should be sparser. If the coefficients are not exactly sparse (not exactly zeros) then the reconstructed signal may encounter an approximation error. The algorithm can also work if the c vector is not sparse, if the rank of matrix A is sufficiently large and the noise is not too large. One of the more difficult conditions to meet is that A and Φ should be mutually incoherent. That is, the coherence between them must be small to be assured of good reconstruction. The coherence between A and Φ is defined as:

$$μ ( A , Φ ) = {max}_{i , j} \vert 〈 {a}_{i} , {φ}_{j} 〉 \vert , \qquad ( 3 )$$

where aᵢ is the i-th row of A, φ_{f} is the j-th column of Φ and [symbol] • [symbol] denotes the inner product. If Φ is selected a priori without knowledge of A, there is no guarantee of incoherence. One can ignore the condition and still perform signal estimation, hoping for the best, but the reconstruction can then fail in some cases. The coherence μ(A, Φ) ranges between 0 and 1. For mutually orthogonal A and Φ, the coherence μ=0. Usually, for normalized A and Φ, the coherence μ(A, Φ) preferably is below 0.1. In the examples below, the μ is approximately 0.03.

Referring back to FIG. 1, the dictionary Φ should have low coherence with the given A and should be well fitted to sparsely represent the input signal x. If this is the case, then the coefficients c can be estimated from measured outputs y and the corresponding x estimate can be determined using Eqn. 2.

The coefficients c can be estimated from y as follows. Begin with the simplified case where A=I. In this case, the measured outputs are just noisy versions of the input signals:

y=x+η=Φ_{c}+η. (4)

If we are given a dictionary Φ and a vector of measurements y, the task is to estimate a sparse vector of coefficients ĉ (and hence also \hat{x}). A MAP estimate in this case is given by:

$$\hat{c} = arg {max}_{c} P ( c \vert y ) = arg {max}_{c} P ( y \vert c ) P ( c ) , \qquad ( 5 )$$

where the second statement comes from Bayes rule. If we assume that the sensor noise η has Gaussian distribution [symbol] (0, σ), then:

$$P ( y \vert c ) ∝ exp ( - \frac{{‖ y - Φ c ‖}_{2}^{2}}{2 {σ}^{2}} ) , \qquad ( 6 )$$

where ∥Φ∥₂ denotes the l₂ norm or Euclidean norm and σ² is the noise variance.

The assumption that the vector of coefficients is sparse is introduced by modeling the prior distribution on c as a Laplace distribution [symbol] (0, α) that is tightly peaked at zero:

$$P ( c ) ∝ exp ( - \frac{{‖ c ‖}_{1}}{α} ) , \qquad ( 7 )$$

where ∥•∥₁ denotes the l₁ vector norm and α is the scale parameter. By substituting Eqns. 6 and 7 into Eqn. 5, the MAP estimation problem now becomes:

$$\hat{c} = arg {max}_{c} [ exp ( - \frac{{‖ y - Φ c ‖}_{2}^{2}}{2 {σ}^{2}} - \frac{{‖ c ‖}_{1}}{α} ) ] , \qquad ( 8 )$$

or equivalently:

$$\hat{c} = arg {min}_{c} [ - log P ( y \vert c ) ] = arg {min}_{c} [ {‖ y - Φ c ‖}_{2}^{2} + λ {‖ c ‖}_{1} ] , \qquad ( 9 )$$

where λ=2σ²/α. This optimization problem is convex and can be solved efficiently using interior point or gradient methods. Moreover, there are guaranteed error bounds for the coefficient estimation, which depend on the coherence of the matrix Φ with itself.

Eqns 4-9 are just one example. Other formulations can be derived for other cases. For example, the noise does not have to be Gaussian. It can be for example Laplacian or Poisson. For the sparse coefficients, their distribution can also be different, but it preferably is kurtotic (peaked at zero). One example is the Cauchy distribution, which also leads to a convex objective function. Thus, Eqns. 8 and 9 can take forms different from those shown above.

In the case where A≠I, then the MAP estimation can be posed as:

$$\hat{c} = arg {min}_{c} [ {‖ y - A Φ c ‖}_{2}^{2} + λ {‖ c ‖}_{1} ] , \qquad ( 10 )$$

and solved in a similar manner as described above. However, the guarantees for the recovery of the correct c (with a small error) are more complicated. Namely, to find a good estimate for c, matrices A and Φ should have low mutual coherence. This condition influences the dictionary learning process because we need to find a dictionary Φ that not only describes the data well but also has low coherence with the system response matrix A.

FIG. 2 is a flow diagram illustrating one method for finding such a dictionary, based on training a dictionary Φ from a training set of input signal examples and simultaneously enforcing incoherence between A and Φ. FIG. 2 begins by selecting 210 an initial dictionary estimate Φ. This could be done by randomly selecting a dictionary, or by using some initial estimate or guess for the dictionary. A loop 220 then iteratively improves this dictionary estimate by using, at each iteration, B samples selected from a training set and organized in a matrix X=[x₁ x₂ . . . x_{B}], referred to as a “sample” X in the following. The improvement is based on an objective function that rewards both low error between the sample X and the sample representation ΦC and also low coherence between A and Φ.

In the specific example of FIG. 2, each iteration of the loop selects 222 a sample X from a training set of input signals. The training set should be representative of the actual inputs, in the sense that the training set preferably contains a large variety of different image examples from the same class and that its size is much larger than the number of dictionary elements, Q>>L. The interior of the loop is a two-step process. In step 224 (sometimes referred to as the inference step), an estimate of C=[c₁ c₂ . . . c_{B}] is inferred based on a sparse prior and assuming the current dictionary estimate Φ. That is, given the current dictionary estimate Φ, find C for the current sample X. In step 226 (referred to as the learning step), the dictionary estimate Φ is adapted, based on assuming the current estimate of C. That is, given the current estimate of C from step 224, find Φ. The loop repeats 228 for additional samples X until sufficient progress is made. For example, the training may stop after a certain number of loops, or after a certain level of convergence is reached, or after a certain level of performance is reached.

In more detail, the inference step 224 can be implemented as

$$\hat{C} = arg {min}_{C} {1}_{} , \\ where {1}_{} = [ {‖ Y - A Φ C ‖}_{2}^{2} + λ {‖ C ‖}_{1} ] \qquad ( 11 )$$

Here, Y is a matrix whose columns are the outputs corresponding to the samples X. If the training set has Q examples, then the second dimension of Y and C would be Q if all of the examples were trained at once. However, since the amount of training data typically is large, at each iteration, we can use a different subset of B randomly chosen examples. Thus, the sizes of Y and C at each iteration are M×B and L×B, respectively. The inference step 224 finds the most probable solution for C under a sparse prior, given the set of outputs Y, the system response matrix A and the current dictionary estimate Φ. The objective function of Eqn. 11 is convex and it can be optimized using gradient methods. The derivative of the objective is simple:

$$\frac{ϑ {1}_{}}{ϑ C} = - 2 {( A Φ )}^{T} ( Y - A Φ C ) + λ sign ( C ) . \qquad ( 12 )$$

The sign function at zero is defined to be equal to zero.

The learning step 226 can be implemented as

$$\hat{Φ} = arg {min}_{Φ} {2}_{} , \\ where \\ {2}_{} = arg {min}_{Φ} [ \frac{1}{B} {‖ X - Φ \hat{C} ‖}_{F}^{2} + δ {‖ A Φ ‖}_{F}^{2} ] . \qquad ( 13 )$$

X is an N×B matrix which columns are examples from the training set and δ is a trade-off parameter.

The first term in this objective function measures the error between the samples X and their representation ΦĈ. It differs from the term in Eqn. 12 because it evaluates the error of the representation of X using Φ. The intuition behind this is that we want to learn a dictionary which does a good job of approximating the examples in the training set using coefficients obtained in the inference step.

The second term in the objective function is the penalty on the coherence between A and Φ. If we take a closer look at the definition of coherence in Eqn. 3, we can see that it is equal to μ=∥AΦ∥_{∞}, i.e. to the infinity norm of AΦ. Since the infinity norm is not differentiable everywhere, we approximate it in this implementation with the Frobenius norm ∥AΦ∥_{F}², i.e., the l₂ matrix norm. This norm is convex and differentiable everywhere, with a simple derivative that is fast to calculate. Alternatively, we can use a norm >2 that would better approximate the infinity norm, but this would increase the computation complexity. Thus, the Frobenius norm represents a good trade-off between performance and complexity.

The objective function in Eqn. 13 is convex and can be minimized using gradient methods. It has a simple derivative over Φ:

$$\frac{\partial }{\partial Φ} = - \frac{2}{B} ( X - Φ \hat{C} ) {\hat{C}}^{T} + 2 δ [ {A}^{T} ( A Φ ) ] . \qquad ( 14 )$$

Since it is based solely on array operations, the derivative calculation is highly parallelizable and convenient for a GPU implementation.

Pseudo-code for this example implementation is shown below.

Pseudo code for dictionary learning

```
Input: training data Xₜ, measurement matrix A, parameters σ, λ, δ, p, L,
B > 4L
[N, Q] = size (Xₜ)
M = size (A, 1)
Initialize dictionary at random: Φ ~ [symbol] ^{N×L}(−0.5, 0.5)
Run learning for p iterations (or until convergence):
for i = 1 → p do
  Randomly select B training signals: X =Xₜ (:, s), s =
  [ t], t ~ [symbol] ^{B×1} (0, Q)
  Generate noisy measurements: Y = AX + η, η ~ [symbol] ^{M×N} (0, σ)
  Initialize coefficients: C₀ = 0
  $solve \text{:} \hat{C} = arg {min}_{C} [ {‖ Y - A Φ \hat{C} ‖}_{2}^{2} + λ {‖ C ‖}_{1} ] ( inference step )$
  $solve \text{:} \hat{Φ} = arg {min}_{Φ} [ \frac{1}{B} {‖ X - Φ \hat{C} ‖}_{F}^{2} + δ {‖ A Φ ‖}_{F}^{2} ] ( learning step )$
  $normalize columns of \hat{Φ} : {\hat{Φ}}_{j} := \frac{{\hat{Φ}}_{j}}{‖ {\hat{Φ}}_{j} ‖ 2} , ∀ j ∈ [ 1 , L ]$
  Φ:= \hat{Φ}
end for
Output: Φ
```

Once we have learned the dictionary Φ that is incoherent with the system response matrix A, we can use it to reconstruct the input signal x from the corresponding output measurements y, for example using the approach described previously.

The approach described above can be used with many different systems and applications. A particular example of a plenoptic imaging system will be described below. In a plenoptic system, light traversing the system is influenced in ways that are more complex than in conventional imaging. As a result, the system response matrix also becomes more complicated compared to a simple convolution with a point spread function, as might be the case for a conventional imaging system. In the following example, the input signal x represents the original object viewed by the plenoptic system, the output signal y is the plenoptic image captured by the system, A represents the system response matrix and η represents system noise. The reconstruction problem is to find x, given y and A.

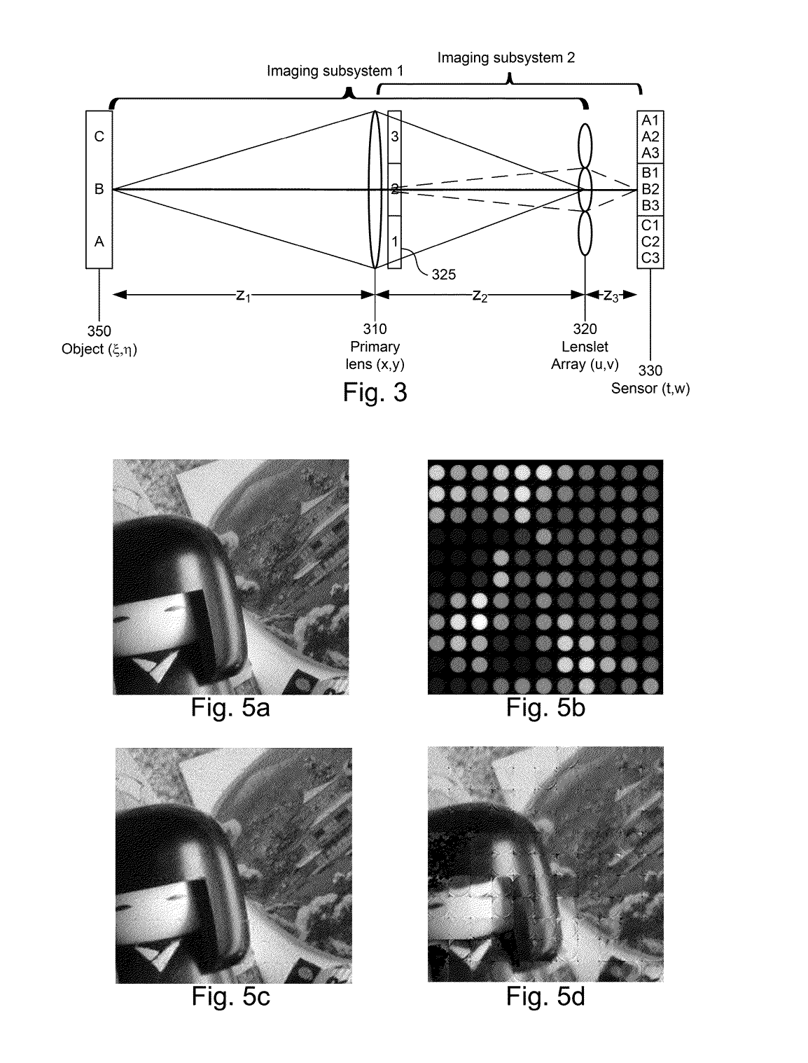

FIG. 3 is a simplified diagram of a plenoptic system. The system includes a primary imaging subsystem 310 (represented by a single lens in FIG. 3), a secondary imaging array 320 (represented by a lenslet array) and a sensor array 330. These form two overlapping imaging subsystems, referred to as subsystem 1 and subsystem 2 in FIG. 3. The plenoptic system optionally may have a filter module 325 positioned at a location conjugate to the sensor array 330. The filter module contains a number of spatially multiplexed filter cells, labeled 1-3 in FIG. 3. For example, the filter cells could correspond to different modalities within the object.

The spatial coordinates (ξ,η) will be used at the object plane (the input to the system) and (t, w) at the sensor plane (the output of the system). In FIG. 3, for simplicity, different components are each located at a single plane. However, in other systems, the different components may be more complex (e.g., the primary “lens” may be a set of lenses spaced apart from each other). In addition, the different components do not have to be designed exactly as shown in FIG. 3. For example, the “primary lens” could be various combinations of elements, including lenses, mirrors and combinations of the two. Similarly, the secondary imaging array could be a pinhole array, or a reflective array.

Ignoring the filter module 325 for the moment, in imaging subsystem 1, the object 350 is imaged by the primary lens 310 to produce an image that will be referred to as the “primary image.” This primary lens 310 may be a camera imaging lens, microscope objective lens or any other such imaging system. The lenslet array 320 is placed approximately at the location of the primary image. Each lenslet then images the pupil of the primary lens to the sensor plane. This is imaging subsystem 2, which partially overlaps with imaging subsystem 1. The image created at the sensor array 330 will be referred to as the “plenoptic image” in order to avoid confusion with the “primary image.” The plenoptic image can be divided into an array of subimages, corresponding to each of the lenslets. Note, however, that the subimages are images of the pupil of imaging subsystem 1, and not of the object 350. In FIG. 3, the plenoptic image and subimages are labeled A1-C3. A1 generally corresponds to portion A of the object 350, as filtered by filter cell 3 in the filter module 325.

The plenoptic system can be modeled as a linear system:

$$[ \begin{matrix}{I}_{f}^{1 , 1} \\ {I}_{f}^{1 , 2} \\ ⋮ \\ {I}_{f}^{1 , W} \\ {I}_{f}^{2 , 1} \\ ⋮ \\ {I}_{f}^{T , W}\end{matrix} ] = [ \begin{matrix}P I {F}_{1 , 1}^{1 , 1} & P I {F}_{1 , 2}^{1 , 1} & … & … & P I {F}_{M , N}^{1 , 1} \\ P I {F}_{1 , 1}^{1 , 2} & P I {F}_{1 , 2}^{1 , 2} & … & … & P I {F}_{M , N}^{1 , 2} \\ ⋮ & ⋮ & ⋮ & ⋮ & ⋮ \\ P I {F}_{1 , 1}^{1 , W} & P I {F}_{1 , 2}^{1 , W} & … & … & P I {F}_{M , N}^{1 , W} \\ P I {F}_{1 , 1}^{2 , 1} & P I {F}_{1 , 2}^{2 , 1} & … & … & P I {F}_{M , N}^{2 , 1} \\ ⋮ & ⋮ & ⋮ & ⋮ & ⋮ \\ P I {F}_{1 , 1}^{T , W} & P I {F}_{1 , 2}^{T , W} & … & … & P I {F}_{M , N}^{T , W}\end{matrix} ] [ \begin{matrix}{I}_{0 , 1 , 1} \\ {I}_{0 , 1 , 2} \\ ⋮ \\ {I}_{0 , 2 , 1} \\ {I}_{0 , 2 , 2} \\ ⋮ \\ {I}_{0 , M , N}\end{matrix} ] \qquad ( 15 A )$$

where I_{f}^{T,W} is the intensity at sensor element T, W; I_{o,M,N} is the intensity from object element M,N; and PIF_{M,N}^{T,W} is the plenoptic imaging system response, which we refer to as the pupil image function or PIF. PIF_{M,N}^{T,W} is the intensity at sensor element T, W produced by object element M,N. T,W is the discretized version of sensor coordinates (t,w) and M,N is the discretized version of object coordinates (ξ,η).

Eqn. 15A can be written more compactly as

[Iv_{f}]=[PIFv][Ivₒ] (15B)

where the additional “v” indicates that these are based on vectorized images. That is, the two-dimensional plenoptic image I_{f} is represented as a one-dimensional vector Iv_{f}. Similarly, the two-dimensional object Iₒ is represented as a one-dimensional vector Ivₒ. Correspondingly, the four-dimensional PIF is represented as a two-dimensional system response matrix PIFv. After a noise term is added, Eqn. 15B takes the same form as Eqn. 1. Iv, is the input vector x, Iv_{f} is the output vector y, and PIFy is the system response matrix A. The PIF can be calculated and approximated in different ways, for example using geometrical optics or based on wave propagation. For examples, see the Appendices in U.S. patent application Ser. No. 13/398,815, “Spatial Reconstruction of Plenoptic Images,” which is incorporated by reference herein.

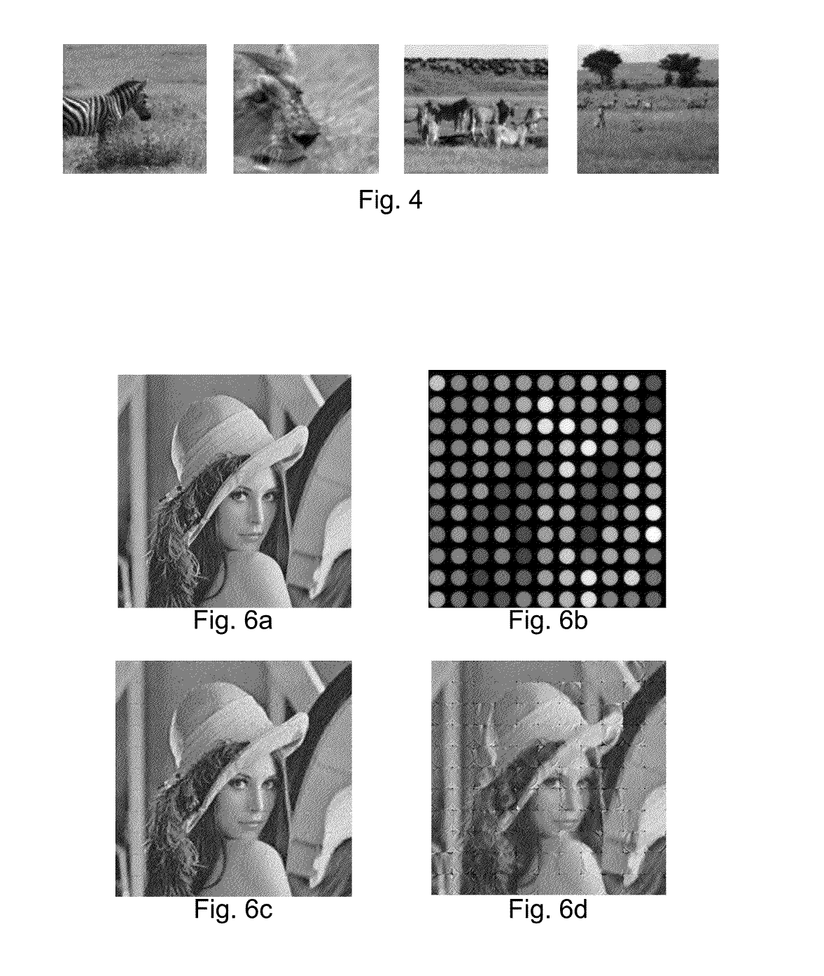

In the following example, the PIF was generated using a wave-propagation analysis, for the case when the object is in focus at the microlens array plane. The training set used for dictionary learning was a set of video frames from a BBC documentary on wildlife, picturing a group of zebras running in the wild. Some of the video frames are shown in FIG. 4. There was no pre-processing on the training set.

The various vectors and matrices have the following sizes. x is N×1, X is N×B, Φ is N×L, c is L×1,C is L×B, y is M×1, Y is M×B, and A is M×N. N is the total number of samples in a digitized version of the object. If considering a one-dimensional object signal and the passband of the system is band-limited with highest frequency f₂, e.g f₂=20, the discretized version of the object sampled at Nyquist rate has 2×20=40 samples in one dimension. For a two-dimensional object, the number of samples at Nyquist rate is N=40×40=1600. M is a sensor sampling of the plenoptic image of this object. M could be as low as N (maintaining the same original Nyquist sampling). Alternatively, rank of A can be smaller even though M is larger (e.g., because of the dark pixels between lenslets and the pixels imaging the same object points). In the following example, we have chosen M=52×52=2704, where the original sampling of 40+a boundary extension of 6 pixels on either side of a super pixel=52 pixels in one dimension at the sensor. We have also chosen L=1600. In each iteration of our learning algorithm we have selected a batch of B=4L=6400 frame blocks of size 40×40. Note that the rank of A is ˜700. That is, rank of A<N/2. Therefore even though M>N, we still have an underdetermined system (number of linearly independent equations is twice smaller than the number of unknowns). Each block was reshaped into a vector and represents a column of X. We have then simulated the plenoptic imaging process using the frame blocks as objects in front of the plenoptic system, placed at the focal plane. Note that this placement does not reduce the generality of the method, since the PIF matrix can be defined for any plane or for the whole volume. Therefore, the simulated data at the sensor plane was:

Y=PIF•X+η (16)

The noise η is white Gaussian noise of SNR=80 dB.

The dictionary Φ was developed using the iterative approach described above. The dictionary estimate Φ was initialized randomly and stopped after approximately 300 iterations, when there was no further significant improvement of the reconstruction quality.

FIGS. 5a-d and 6a-d are images illustrating dictionary-based reconstruction for a doll object and for a Lena object, respectively. The doll and Lena images were taken as objects in front of the plenoptic system. For each 40×40 block of the original object, we have simulated the sensor data as in Eqn. 16 with added white Gaussian noise of SNR=80 dB. Using the inference step given by Eqn. 11, we have estimated the sparse coefficient vectors Ĉ and the reconstructed blocks are then obtained as \hat{X}=ΦĈ. FIGS. 5a and 6a show the original objects (input signal x). FIGS. 5b and 6b show the corresponding plenoptic images captured at the sensor (output signal y). Note that the plenoptic image is an array of circular images. The circular footprint is because the primary lens has a circular aperture, and each microlens images the primary lens onto a corresponding section of the sensor array. The intensity within each circular footprint is not constant, but the variation cannot be easily seen at the magnifications shown in FIGS. 5b and 6b.

FIGS. 5c and 6c show reconstructed objects using the dictionary-based approach described above. For comparison, FIGS. 5d and 6d show reconstructed objects using an alternate approach, based on non-linear least square fitting with additional smoothing. To evaluate the quality of reconstructed images we have used the Peak Signal to Noise Ratio (PSNR). The PSNR for the dictionary-based reconstructions in FIGS. 5c and 6c are higher, around 29 dB, whereas the PSNR for the reconstructions shown in FIGS. 5d and 6d are lower, around 23 dB. The visual quality of the dictionary-based reconstruction is also better.

This is just one example application. Other applications will be apparent. The example above did not make use of a filter module 325. One application for plenoptic systems is spectral filtering. The filter module 325 can include different wavelengths. This system can be modeled by

[Iv_{f}]=[[PIFv₁][PIFv₂] . . . [PIFv_{K}]][[Ivₒ₁]^{T}[Ivₒ₂]^{T} . . . [Iv_{oK}]^{T}]^{T} (17)

Here, the plenoptic image Iv_{f} has the same dimensions as before. However, the object Ivₒ is made up of K different components Ivₒₖ. For example, Ivₒ₁ might be the component of the object at wavelength band 1, Ivₒ₂ might be the component of the object at wavelength band 2, and so on. The corresponding “component PIFs” could include PIFᵥ₁, PIFv₂ and so on, where the component PIFv₁ represents the contribution of the component Ivₒ₁ to the captured plenoptic image, component PIFv₂ represents the contribution of the component Ivₒ₂ to the captured plenoptic image, etc. The basic equation [Iv_{f}]=[PIFv] [Iv ₒ] still holds, except that now the matrix [PIFv]=[[PIFv₁] . . . [PIFv_{K}]] and the vector [Ivₒ]=[[Ivₒ₁]^{T} [Ivₒ₂]^{T} . . . [Iv_{oK}]^{T}]^{T}. This makes the system response matrix A even more rank deficient than before, making it even harder to reconstruct. The components could also be based on other characteristics: polarization, attenuation, object illumination or depth, for example.

Another example application is ultrasound tomography. In this example, the input x is an object to be imaged by the system, and the output y is ultrasound samples taken by the ultrasound tomography system. Yet another example application is MRI imaging. The input x is an object to be imaged by the system, and the output y is MRI samples taken by the MRI imaging system. Yet another example is ground penetrating radar tomography.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

In alternate embodiments, the invention is implemented in computer hardware, firmware, software, and/or combinations thereof. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

The term “module” is not meant to be limited to a specific physical form. Depending on the specific application, modules can be implemented as hardware, firmware, software, and/or combinations of these.

What is claimed is:

1. For a system that can be characterized by y=Ax+η, where x represents input to the system, A represents a rank-deficient system response matrix, η represents system noise and y represents output of the system, a computer-implemented method for determining a dictionary Φ for the system, whereby x=Φc, the method comprising:
selecting an initial dictionary estimate Φ; and
repeatedly performing the steps of:
selecting a sample X from a training set of system inputs; and
improving the dictionary estimate Φ based on an objective function that rewards a low error between the sample X and the sample representation ΦC and that also rewards a low coherence between A and Φ.

2. The method of claim 1 wherein c is sparse.

3. The method of claim 1 wherein the objective function rewards low coherence by including a term based on
$$μ ( A , Φ ) = {max}_{i , j} \vert 〈 {a}_{i} , {φ}_{j} 〉 \vert ,$$
where aᵢ is the i-th row of A, φⱼ is the j-th column of Φ and [symbol] • [symbol] denotes the inner product.

4. The method of claim 1 wherein the dictionary estimate is improved such that μ(A, Φ)<0.1 for normalized A and Φ.

5. The method of claim 1 wherein the objective function rewards low coherence by including a term based on ∥AΦ∥_{F}², where ∥•∥_{F}² denotes the l₂ matrix norm.

6. The method of claim 1 wherein the objective function rewards low error by including a term based on ∥X−ΦC∥_{F}², where ∥•∥_{F}² denotes the l₂ matrix norm.

7. The method of claim 1 wherein the step of improving the dictionary estimate Φ comprises iteratively performing the steps of:
inferring an estimate of C, based on a sparse prior and assuming the current dictionary estimate Φ; and
adaptively learning Φ, based on assuming the current estimate of C.

8. The method of claim 1 wherein the step of inferring an estimate of C is based on an objective function that is convex.

9. The method of claim 1 wherein the step of inferring an estimate of C is based on finding the most probable solution C for a sparse prior, given A, the current dictionary estimate Φ, and an output Y that corresponds to the sample X.

10. The method of claim 9 wherein the step of inferring an estimate of C is based on
$$\hat{C} = arg {min}_{C} {1}_{} ,$$
where [symbol] ₁=[∥Y−AΦC∥₂²+λ∥C∥₁].

11. The method of claim 10 wherein the step of inferring an estimate of C uses a gradient method based on
$$\frac{ϑ {1}_{}}{ϑ C} = - 2 {( A Φ )}^{T} ( Y - A Φ C ) + λ sign ( C ) .$$

12. The method of claim 1 wherein the step of adaptively learning Φ is based on an objective function that is convex.

13. The method of claim 1 wherein the step of adaptively learning Φ is based on the objective function that has a first term that penalizes an error between the sample X and the sample representation ΦC and that has a second term that penalizes coherence between A and Φ.

14. The method of claim 13 wherein the step of adaptively learning Φ is based on
$$\hat{Φ} = arg {min}_{Φ} {2}_{} , \\ where$$
$${2}_{} = arg {min}_{Φ} [ \frac{1}{B} {‖ X - Φ \hat{C} ‖}_{F}^{2} + δ {‖ A Φ ‖}_{F}^{2} ] ,$$

15. The method of claim 14 wherein the step of adaptively learning Φ uses a gradient method based on
$$\frac{\partial {2}_{}}{\partial Φ} = - \frac{2}{B} ( X - Φ \hat{C} ) {\hat{C}}^{T} + 2 δ [ {A}^{T} ( A Φ ) ] .$$

16. The method of claim 1 further comprising:
receiving an observed output y₁; and
estimating the corresponding input x₁ based on A, η and the determined dictionary estimate Φ.

17. The method of claim 16 wherein the step of estimating x₁ comprises:
estimating c₁ using convex optimization; and
estimating x₁ according to x₁=Φc₁.

18. The method of claim 1 wherein the input x is an N×1 vector, c is an L×1 vector, the dictionary Φ is an N×L matrix, and L>N.

19. For a plenoptic system that can be characterized by y=PIF x+η, where x represents an object to be imaged by the plenoptic system, PIF represents a rank-deficient matrix of the pupil image function, η represents system noise and y represents a plenoptic image of the object taken by the plenoptic system, a computer-implemented method for determining a dictionary Φ for the plenoptic system, whereby x=Φc, the method comprising:
selecting an initial dictionary estimate Φ; and
repeatedly performing the steps of:
selecting a sample X from a training set of objects; and
improving the dictionary estimate Φ based on an objective function that rewards a low error between the sample X and the sample representation ΦC.

20. A dictionary-enhanced system comprising:
a system that can be characterized by y=Ax+η, where x represents input to the system, A represents a rank-deficient system response matrix, η represents system noise and y represents output of the system;
data storage containing a dictionary Φ for the system, whereby x=Φc and A and Φ have mutual coherence μ(A, Φ)<0.1; and
a reconstruction module coupled to the system and the data storage, wherein the reconstruction module receives an observed output y₁ from the system and estimates the corresponding input x₁ based on A, η and the stored dictionary Φ.
